(19) United States
(12) Patent Application Publication
(10) Pub. No.: US 2026/0004408 A1
(43) Pub. Date: Jan. 1, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Masahiro TSUJIBAYASHI, Chiba (JP); Kiyokatsu IKEMOTO, Kanagawa (JP); Yosuke EGUCHI, Tokyo (JP); Rintaro TODA, Tokyo (JP)

(21) Appl. No.: 19/242,384

(22) Filed: Jun. 18, 2025

(30) Foreign Application Priority Data
Jul. 1, 2024 (JP) 2024-106475

(51) Int. Cl. G06T 5/77; G06T 7/00; G06T 7/13; G06T 7/50; G06T 19/20

(52) U.S. Cl. CPC G06T 5/77; G06T 7/0002; G06T 7/13; G06T 7/50; G06T 19/20; G06T 2207/10028; G06T 2207/30168; G06T 2210/56; G06T 2219/2016

(57) ABSTRACT

An image processing apparatus includes: an information acquisition unit configured to acquire an image and distance information of a subject; a 3D data generation processing unit configured to generate 3D data of the subject based on the image and the distance information; an error region detection unit configured to detect an error region of the 3D data; and an image adjustment unit configured to adjust image information of the error region.

### BACKGROUND

### Field of the Technology

The present disclosure relates to an image processing apparatus, an image processing method, and a storage medium.

### Description of the Related Art

For example, Japanese Patent Application Laid-open No. 2024-8596 discloses an image processing apparatus capable of generating a three-dimensional image by acquiring distance information at the same time as when one still image is captured, and processing the image based on the distance information.

In the configuration disclosed in Japanese Patent Application Laid-open No. 2024-8596, for example, when a face is imaged during rotation of a three-dimensional image generated through image processing, a side surface of the face (an ear or the like) may be stretched or a side surface of a neck (a cheek, a neck, or the like) or a missing portion may occur in the three-dimensional image of the side surface of the neck (a cheek, a neck, or the like) during rotation of the three-dimensional image generated through the image processing.

### SUMMARY

According to an embodiment of the present disclosure, an image processing apparatus includes: an information acquisition unit configured to acquire an image and distance information of a subject; a 3D data generation processing unit configured to generate 3D data of the subject based on the image and the distance information; an error region detection unit configured to detect an error region of the 3D data; and an image adjustment unit configured to adjust image information of the error region.

Further features of the present disclosure will become apparent from the following description of embodiments with reference to the attached drawings.

### BRIEF DESCRIPTION OF THE DRAWINGS

FIG. 1 is a functional block diagram illustrating a configuration example of an imaging apparatus 100 according to a first embodiment of the present disclosure.

FIG. 2 is a flowchart illustrating an example of image processing according to the first embodiment.

FIG. 3 is a flowchart illustrating a detailed example of a 3D data generation process of step S21.

FIG. 4A is a diagram illustrating an example of a three-dimensional image obtained in step S20, FIG. 4B is a diagram illustrating an example of a distance map, FIG. 4C is a diagram illustrating an example of a mesh image generated based on point group data, and FIG. 4D is a diagram illustrating an example of a texture image of a three-dimensional image generated based on the mesh image of FIG. 4C.

FIG. 5 is a flowchart illustrating a detailed example of an adjustment process of step S22.

FIG. 6A is a flowchart illustrating a detailed process example of 3D data error detection in step S50 and FIG. 6B is a diagram illustrating an example in which an example of semantic labeling is applied to a three-dimensional image in the flowchart of FIG. 6A.

FIG. 7A is a flowchart illustrating another processing example of 3D data error detection in step S50 and FIG. 7B is a diagram illustrating an example of a distance map in a processing flow of FIG. 7A.

FIG. 8A is a flowchart illustrating still another processing example of 3D data error detection in step S50 and FIG. 8B is a diagram illustrating an example of a region where a polygon of a three-dimensional image is large in a processing flow of FIG. 8A.

FIG. 9 is a flowchart illustrating an example of an image adjustment process of step S51.

FIG. 10 is a flowchart illustrating another example of the image adjustment process of step S51.

FIG. 11 is a flowchart illustrating an example of image processing according to a second embodiment.

FIG. 12A is a flowchart illustrating a missing-portion detection processing example in step S1103, FIG. 12B is a diagram illustrating an example of a three-dimensional image when there is no missing portion, and FIG. 12C is a diagram illustrating an example of a three-dimensional image when there is a missing portion.

FIG. 13A is a flowchart illustrating another example of the missing-portion detection processing example in step S1103, FIG. 13B is a diagram illustrating an example of a three-dimensional image when a missing portion occurs, and FIG. 13C is a diagram illustrating an example of a three-dimensional image of a model.

FIG. 14A is a flowchart illustrating still another example of the missing-portion detection processing example in step S1103 and FIG. 14B is a diagram illustrating an example of an edge of a three-dimensional image when a missing portion occurs.

FIG. 15 is a flowchart illustrating an example of an image interpolation process of step S1104.

FIG. 16 is a flowchart illustrating another example of the image interpolation process of step S1104.

FIG. 17 is a flowchart illustrating still another example of the image interpolation process of step S1104.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

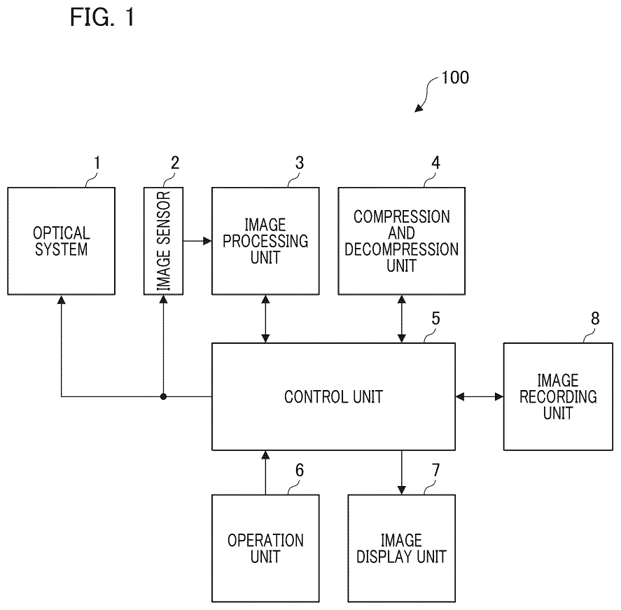

FIG. 1 is a functional block diagram illustrating a configuration example of an imaging apparatus 100 according to a first embodiment of the present disclosure. Some functional blocks illustrated in FIG. 1 are implemented by causing a CPU or the like serving as a computer (not illustrated) included in the imaging apparatus 100 to execute a computer program stored in a memory serving as a storage medium (not illustrated). However, some of all of the functional blocks may be implemented by hardware.

As the hardware, a dedicated circuit (ASIC), a processor (a reconfigurable processor or a DSP), or the like can be used. Each functional block illustrated in FIG. 1 may not be contained in the same casing or may be configured by other apparatuses connected to each other via a signal line.

The imaging apparatus 100 can be applied to a digital still camera, a digital video camera, an on-vehicle camera, a surveillance camera, a smartphone, or the like. The imaging apparatus 100 includes an optical system 1, an image sensor 2, an image processing unit 3, a compression and decompression unit 4, a control unit 5, an operation unit 6, an image display unit 7, and an image recording unit 8. The imaging apparatus 100 according to the present embodiment functions as an image signal processing apparatus.

The optical system 1 includes a lens, a lens driving mechanism, a mechanical shutter mechanism, and a diaphragm mechanism. The movable units are driven based on control signals from the control unit 5.

The image sensor 2 is, for example, an XY address type complementary metal oxide semiconductor (CMOS) image sensor and performs an imaging operation in accordance with a control signal from the control unit 5. Further, an imaging signal is digitized by an AD conversion circuit included in the image sensor 2 and the digitized imaging signal is output as an image signal to the image processing unit 3.

In the image sensor 2 according to the present embodiment, for example, first and second photoelectric conversion elements are juxtaposed in each pixel. Common microlenses are disposed on light incidence surfaces of the first and second photoelectric conversion elements. Accordingly, light from each of different exit pupils of the imaging lenses included in the optical system 1 is incident to each of the first and second photoelectric conversion elements.

Accordingly, a first image signal obtained from a group of the first photoelectric conversion elements of a plurality of pixels and a second image signal obtained from a group of the second photoelectric conversion elements of the plurality of pixels have a parallax. The image sensor 2 can read, as display image data, a signal obtained by adding signals of the first and second photoelectric conversion elements for each pixel.

The image sensor 2 may be configured to output the first and second image signals, for example, separately. The image sensor 2 may be configured to read the first image signal and the image data added for each pixel separately. Accordingly, the image processing unit 3 at the rear stage can calculate the second image signal by subtracting the first image signal from the above-described added image data.

The image processing unit 3 generates a distance image (distance map) by calculating distance information for a subject based on a correlation distance between the first and second image signals obtained from the image sensor 2. A three-dimensional image is generated based on the image signals and the distance image (distance map).

The image processing unit 3 also performs image processing such as noise correction, and white balance processing on a digitized image signal input from the image sensor 2 under the control of the control unit 5. The image processing unit 3 generates a control signal for controlling a focus lens of the optical system 1 based on the above-described distance information and generates a control signal for controlling a diaphragm or an accumulation time of the image sensor based on luminance information of the image signal.

The image signal or the control information subjected to the image processing in the image processing unit 3 is output to the control unit 5. At least a part of the image processing of generating a three-dimensional image may be performed by an external image processing apparatus different from the imaging apparatus 100.

The compression and decompression unit 4 operates under the control of the control unit 5 and performs a compression encoding process on the image signal or a decompression decoding process on the encoded image of a still image. A compression encoding/decompression decoding process on a moving image may be performed.

The control unit 5 is a microcontroller configured in a central processing unit (CPU), a read only memory (ROM), or a random access memory (RAM).

A CPU serving as a computer in the control unit 5 generally controls each unit of the entire imaging apparatus 100 by executing a computer program stored in a storage medium such as a ROM. The operation unit 6 is configured with any of various operation members such as a shutter release button and outputs a control signal in response to an input operation by a user to the control unit 5. As examples of the input operation by the user, setting of a recording mode of a still image or a moving image, exposure control (a diaphragm, an accumulation time of an image sensor, or ISO sensitivity), and the like can be performed.

The image display unit 7 supplies an image signal to a display device such as a liquid crystal display (LCD) and displays an image. The image recording unit 8 is connected to, for example, a portable recording medium and stores an image data file subjected to compression encoding.

The image recording unit 8 may further record the image data file in association with the distance image (distance map). Alternatively, the image recording unit 8 may record the first and second image signals as image data files. Alternatively, the image recording unit 8 may be able to record the display image data added for each pixel and the first image signal and subsequently calculate the second image signal.

As described above, the image data file, the distance image (distance map), and the like can be read from the image recording unit 8 at any timing after imaging to generate a three-dimensional image. The imaging apparatus 100 may include a communication unit, and thus can transmit the image data and the distance image (distance map) recorded on the image recording unit 8 to an external image processing apparatus, for example. Accordingly, the external image processing apparatus can generate 3D data (three-dimensional image).

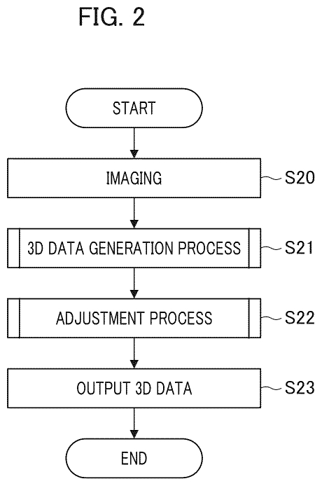

FIG. 2 is a flowchart illustrating an example of image processing according to the first embodiment. The CPU or the like serving as the computer in the control unit 5 sequentially performs operations of steps of the flowchart of FIG. 2 and other flowcharts in the following description by executing the computer program stored in the memory.

A processing flow of FIG. 2 starts when an instruction to generate a three-dimensional image is given by the operation unit 6. In step S20, for example, imaging is performed using the image sensor 2. Alternatively, image data stored in the image recording unit 8 is acquired.

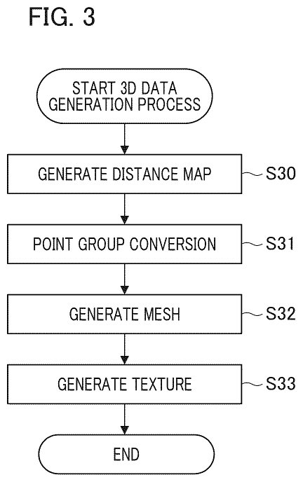

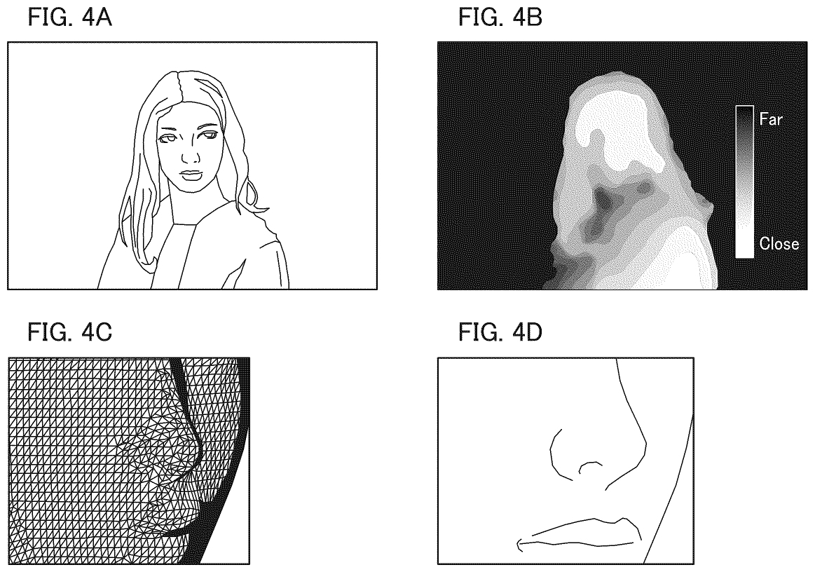

In step S21, a 3D data generation process is performed. That is, a process of generating a three-dimensional image is performed based on the image data, the distance image (distance map), and the like. The 3D data according to the present embodiment is a three-dimensional image up to a predetermined rotation angle range from the front. A detailed example of step S21 will be described with reference to FIGS. 3 and 4A to 4D.

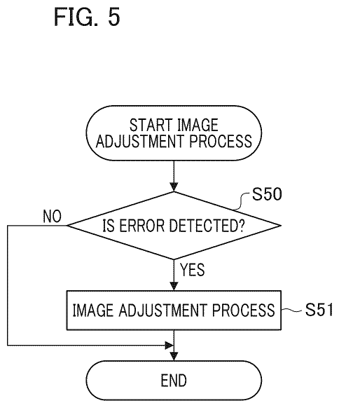

In step S22, an adjustment process for the 3D data is performed. In step S23, the adjusted 3D data is output. A detailed example of step S22 will be described with reference to FIGS. 5 to 8.

FIG. 3 is a flowchart illustrating a detailed example of a 3D data generation process of step S21. In step S30, the distance map is newly generated. Alternatively, when the image data is acquired from the image recording unit 8 in step S20 and the distance map associated with the image data is read, the distance map is acquired.

Here, steps S30 and S20 function as an information acquisition step (information acquisition unit) of acquiring an image and distance information of a subject.

FIG. 4A is a diagram illustrating an example of the three-dimensional image obtained in step S20 and FIG. 4B is a diagram illustrating an example of a distance map. As illustrated in FIG. 4B, as density becomes higher, a distance increases. In step S31, point group conversion is performed based on data of the distance map to obtain the point group data.

In step S32, a mesh image is generated based on the point group data. FIG. 4C is a diagram illustrating an example of a mesh image generated based on point group data. In step S33, a texture image is generated based on the mesh image.

FIG. 4D is a diagram illustrating an example of a texture image of a three-dimensional image generated based on the mesh image of FIG. 4C. The texture image is output as 3D data. When the process of step S33 ends, the process proceeds to the adjustment process of step S22 in FIG. 2. Here, steps S31 to S33 function as a step of a 3D data generation process (3D data generation processing unit) of generating the 3D data of the subject based on the image and the distance information.

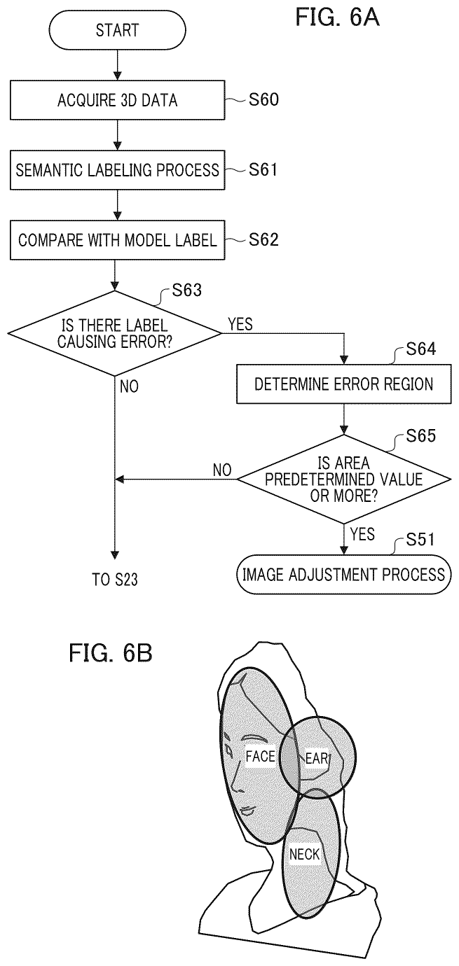

FIG. 5 is a flowchart illustrating a detailed example of an adjustment process of step S22. In step S50, error detection for the 3D data is performed. Here, step S50 functions as an error region detection step (error region detection unit) of detecting an error region of the 3D data. A detailed example of the error detection for the 3D data in step S50 will be described with reference to FIGS. 6 to 8.

When an error is detected in the 3D data in step S50, the image adjustment process is performed in step S51. Here, step S51 functions as an image adjustment step (image adjustment unit) of adjusting image information of the error region.

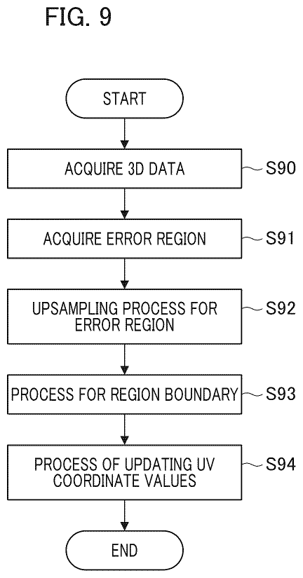

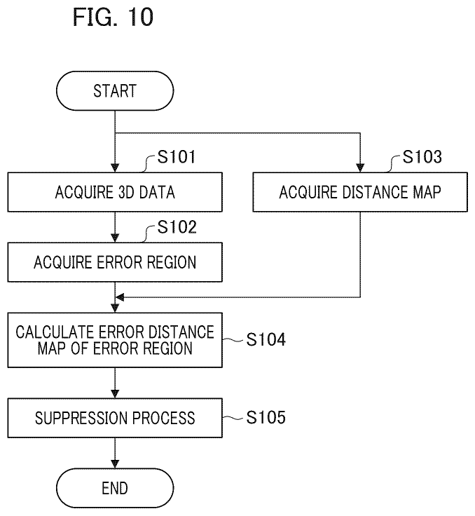

When no error is detected in the 3D data in step S50, the processing flow of FIG. 5 ends and the process proceeds to step S23 of FIG. 2. A detailed example of the image adjustment process of step S51 will be described with reference to FIGS. 9 and 10.

FIG. 6A is a flowchart illustrating a detailed process example of 3D data error detection in step S50 and FIG. 6B is a diagram illustrating an example in which an example of semantic labeling is applied to a three-dimensional image in the flowchart of FIG. 6A. In an example of FIG. 6A, the error region in the 3D data is detected by determining a semantic region of the 3D data by machine learning or deep learning.

In step S60 of FIG. 6A, the 3D data generated in step S21 is acquired. A semantic labeling process is performed on the 3D data in step S61. That is, for example, a face, ears, a neck, and the like are classified in each partial region of the image through image recognition and labeling of the face, the ears, the neck, and the like is performed, as illustrated in FIG. 6B.

In step S62, comparison and collation of model label arrangement are performed. That is, comparison with the arrangement of model labels trained in advance by machine learning or deep learning is performed.

In step S63, it is determined whether there is a label that may cause an error. Specifically, the collation is performed, for example, by determining whether there is unnatural arrangement (for example, positions of the ears are above the face) in the arrangement of semantic labels as a result of the comparison with the model labels or determining whether balance of sizes of the face, the ears, and the neck is within a normal range.

When NO is determined in step S63, the flow of FIG. 6A ends and the process proceeds to step S23. Conversely, when YES is determined in step S63, an error region is determined in step S64. That is, a label causing an error is determined as an error region.

In step S65, it is determined whether an area of the error region is a predetermined value or more. When NO is determined in step S65, the processing flow of FIG. 6A ends and the process proceeds to step S23. Conversely, when YES is determined in step S65, the process proceeds to the image adjustment process of step S51.

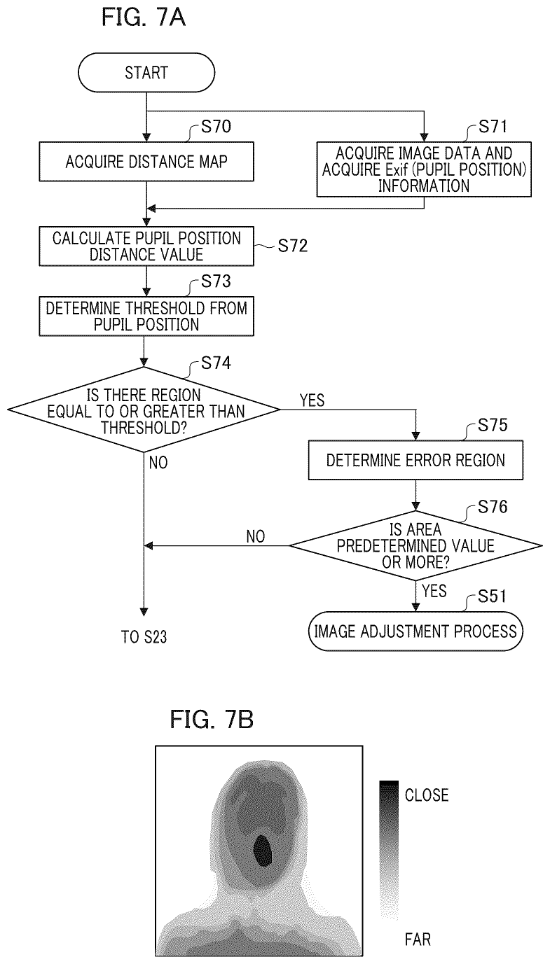

FIG. 7A is a flowchart illustrating another processing example of the 3D data error detection in step S50 and FIG. 7B is a diagram illustrating an example of a distance map in a processing flow of FIG. 7A. In the processing flow of FIG. 7A, a region of which distance is equal to the predetermined value or more in the 3D data is detected as an error region based on the distance information.

In step S70 of FIG. 7A, for example, a distance map is acquired as in FIG. 7B. On the other hand, image data is acquired in step S71. It is assumed that the image data acquired in step S71 includes pupil position information in an EXIF format. That is, information regarding positions (coordinates) of pupils of a face that is a main subject is included as metadata in the image data.

In step S72, distance values of the pupil positions are calculated based on the distance map and the positions (coordinates) of the pupils. In step S73, a threshold indicating an allowable range from the distance values of the pupil positions is determined. The threshold may be determined based on, for example, a ratio of a resolution of a polygon formed by the point group data in step S31 of FIG. 3 to a resolution of the subject.

Alternatively, a distance value in which a gradient of a distance change is a predetermined value or more may be determined as the threshold. Alternatively, a difference value of a preset distance may be determined as the threshold.

In step S74, it is determined whether there is a region of which an area is the threshold or more in the distance map. That is, it is determined whether there is a region of which a distance is away from the distance of the pupil position by the threshold. When NO is determined in step S74, the processing flow of FIG. 7A ends and the process proceeds to step S23.

Conversely, when YES is determined in step S74, the region of which the distance is away from the distance of the pupil position by the threshold is determined as an error region in step S75 and it is determined in step S76 whether an area of the error region is the predetermined value.

When NO is determined in step S76, the processing flow of FIG. 7A ends and the process proceeds to step S23. Conversely, when YES is determined in step S76, the process proceeds to the image adjustment process of step S51.

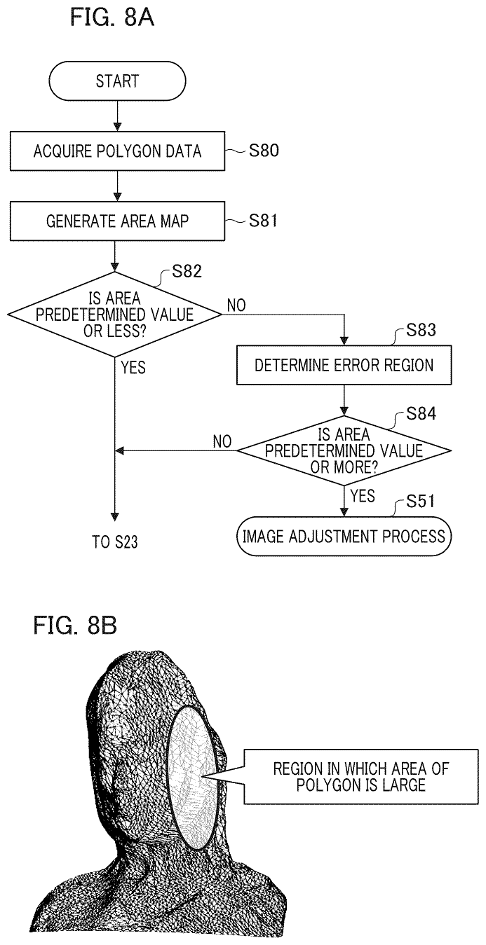

FIG. 8A is a flowchart illustrating still another processing example of the 3D data error detection in step S50 and FIG. 8B is a diagram illustrating an example of a region where a polygon of a three-dimensional image is large in a processing flow of FIG. 8A.

In step S80, polygon data (mesh data) is acquired based on the point group data in step S31. Subsequently, in step S81, an area of each polygon (each mesh) is calculated based on the polygon data (mesh data) and an area map is generated. In step S82, it is determined whether the area of each polygon (each mesh) is the threshold or less.

When NO is determined in step S82, the processing flow of FIG. 8A ends and the process proceeds to step S23. Conversely, when YES is determined in step S82, an area in which an area of each polygon (each mesh) is greater than the threshold is determined as an error region in step S83. FIG. 8B illustrates an example of a region in which an area of each polygon (each mesh) is greater than the threshold.

In step S84, it is determined whether the area of the error region is the predetermined value or more. When NO is determined, the processing flow of FIG. 8A ends and the process proceeds to step S23. Conversely, when YES is determined in step S84, the process proceeds to the image adjustment process of step S51.

As described above, in step S50, the error detection is performed by performing any process in FIGS. 6 to 8. In step S50, the processes in FIGS. 6 to 8 may be performed in combination. In the present embodiment, at least one of the error detection processes in FIGS. 6 to 8 may be performed in step S50.

FIG. 9 is a flowchart illustrating an example of an image adjustment process of step S51. In the example illustrated in FIG. 9, the image adjustment unit performs at least one of an upsampling process and an image suppression process on the error region.

In step S90, the 3D data is acquired. In step S91, information regarding the error region detected in step S50 is acquired. Subsequently, in step S92, the upsampling process for the error region is performed.

That is, for example, when the error region is reduced, sampling of the region extends to enlarge the region. For example, in the process of FIG. 6A, when a width of a region of an ear is narrower than a model label, upsampling is performed so that the width is enlarged.

At that time, a resolution of the upsampling is set to a resolution at which sizes of polygons in the depth direction and the horizontal direction are the same. Alternatively, a resolution is set so that the area is the same as the size of the polygon of the pupil of the face.

Subsequently, in step S93, image suppression processes (for example, filtering and smoothing processes) are performed so that a boundary between the region subjected to the upsampling process of step S92 and another region is inconspicuous. A process of updating UV coordinate values is performed in step S94. After the process of step S93, step S23 is performed. Here, in step S93, at least one of the image suppression processes is performed.

FIG. 10 is a flowchart illustrating another example of the image adjustment process of step S51. In step S101, the 3D data is acquired. In step S102, information regarding the error region detected in step S50 is acquired. On the other hand, in step S103, the distance map is acquired.

Subsequently, in step S104, the distance map of the error region is extracted. In step S105, an image suppression process is performed so that the image is inconspicuous. The suppression process of step S105 includes, for example, a process of reducing at least one of luminance, saturation, contrast, and transparency of the error region.

The suppression process is gradually strongly performed so that the image is inconspicuous in accordance with an error amount (for example, a distance difference from the position of the pupil position). That is, the suppression process is strongly performed in accordance with the extent of an error of the error region. As an error amount. the size of the polygon may be used.

That is, as the area of each polygon (each mesh) illustrated in FIG. 8B is larger, the suppression process may be performed more strongly. Since an error amount is larger toward a peripheral portion of a subject, the suppression process may be gradually performed more strongly toward the peripheral portion of the subject.

As described above, according to the first embodiment, a 3D image with a small feeling of discomfort can be obtained by detecting an error region of the 3D image and performing the image suppression process so that the error region is inconspicuous. The image adjustment process of step S51 may be performed in combination with the processes illustrated in FIGS. 9 and 10, or at least one of the processes illustrated in FIGS. 9 and 10 may be performed.

### Second Embodiment

In a second embodiment, a 3D image with a small feeling of discomfort is obtained by detecting an error region of the 3D data and interpolating the error region. The first and second embodiments may be combined.

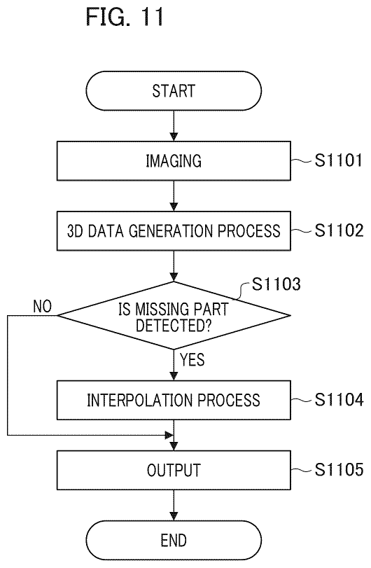

FIG. 11 is a flowchart illustrating an example of image processing according to the second embodiment. Steps S1101 and S1102 are the same as steps S20 and S21, respectively, and thus description thereof will be omitted. In step S1103, a missing portion is detected in the image. When the missing portion is detected, the process proceeds to step S1104. When the missing portion is not detected, the process proceeds to step S1105.

Step S1103 functions as an error region detection unit that detects an error region of the 3D data. That is, in the second embodiment, the missing portion is detected as an error region of the 3D data. In this way, the error region includes the missing region in the 3D data.

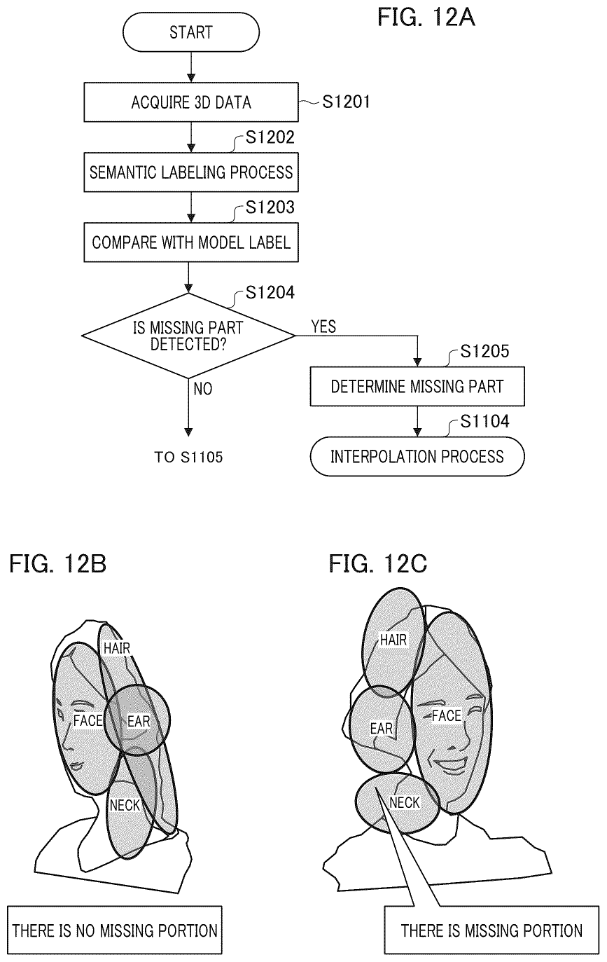

FIG. 12A is a flowchart illustrating a missing-portion detection processing example in step S1103, FIG. 12B is a diagram illustrating an example of a three-dimensional image when there is no missing portion, and FIG. 12C is a diagram illustrating an example of a three-dimensional image when there is a missing portion. FIG. 12B is the same as FIG. 6B and illustrates a state where the image is distorted and has no missing portion. In FIG. 12A, a missing portion of the 3D data is detected based on an arrangement relationship of a semantic region of the 3D data.

On the other hand, in FIG. 12C, a missing portion occurs in a neck part. In FIG. 12A, steps S1201 to S1203 are the same as steps S60 to S62 of FIG. 6, and thus description thereof will be omitted.

In step S1204, it is determined whether there is a label in which a missing portion occurs. That is, the collation is performed, for example, by determining whether a missing portion occurs in the arrangement of the semantic label as a result of the comparison with the arrangement of the model labels trained in advance by machine learning or deep learning. For example, as illustrated in FIG. 12C, when the width of the neck is narrowed with the neck not covered with hair, it is determined that the missing portion occurs in a label region of the neck. For example, when a part of the neck is covered with the hair, it may be determined that there is no missing portion.

When NO is determined in step S1204, that is, it is determined that there is no missing portion, the processing flow of FIG. 12A ends and the process to the output process of step S1105 in FIG. 11. Conversely, when YES is determined in step S1204, a missing portion is determined in step S1205. That is, a partial region where the missing portion occurs is determined as a missing region. After the process of step S1205, the process proceeds to the interpolation process of step S1104 of FIG. 11.

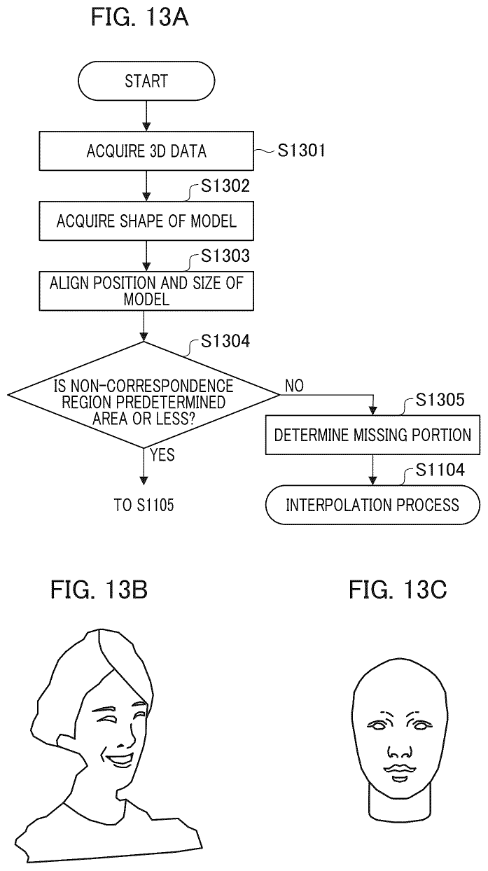

FIG. 13A is a flowchart illustrating another example of the missing-portion detection processing example in step S1103, FIG. 13B is a diagram illustrating an example of a three-dimensional image when a missing portion occurs, and FIG. 13C is a diagram illustrating an example of a three-dimensional image of a model. In examples illustrated in FIGS. 13A to 13C, the error region detection unit detects an error (missing portion) of a shape of 3D data, and a missing region is detected based on a comparison result between the 3D data and a three-dimensional shape of a model stored in advance.

In step S1301, the 3D data is acquired. In step S1302, a three-dimensional shape of a model illustrated in FIG. 13C is acquired. As the shape of the model, a shape of the model generated in advance and viewed from the front is used. For example, a shape of the model viewed obliquely right or left from the front side may be used.

In step S1303, a position and a size of the 3D data acquired in step S1301 are aligned with a shape and a size of the shape of the model acquired in step S1302. At that time, the 3D data may be aligned with the position or the size of the shape of the model based on an imaging condition (a distance to a subject, zoom information of a lens, or the like) or organ information.

In step S1304, it is determined whether a non-correspondence region where the positions or the sizes of the shape of the model and the 3D data do not match is a predetermined area or less. When YES is determined in step S1304, the processing flow of FIG. 13A ends and the process proceeds to the output process of step S1105. Conversely, when NO is determined in step S1304, the non-correspondence region is determined as a missing portion in step S1305 and the process proceeds to the interpolation process of step S1104.

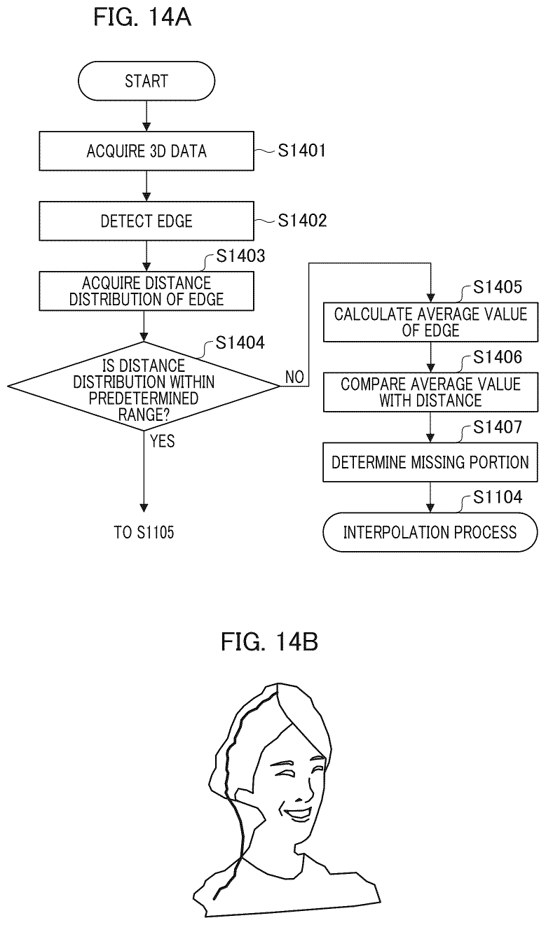

FIG. 14A is a flowchart illustrating still another example of the missing-portion detection processing example in step S1103 and FIG. 14B is a diagram illustrating an example of an edge of a three-dimensional image when a missing portion occurs. In an example of FIG. 14A, a portion that has an average value from a distance distribution of the edge is detected as a missing portion. That is, in the example of FIG. 14A, an error of an image of the 3D data is detected. In particular, the missing portion is detected based on the distance distribution of the edge of the 3D data.

In step S1401 of FIG. 14A, the 3D data is acquired. In step S1402, an edge is detected from the 3D data. In step S1403, a distance distribution of the edge detected in step S1402 is acquired.

In step S1404, it is determined whether a range of the distance distribution acquired in step S1403 is a predetermined range or less. When YES is determined in step S1404, the processing flow of FIG. 14A ends and the process proceeds to the output process of step S1105.

Conversely, when NO is determined in step S1404, the process proceeds to step S1405 to calculate an average value of the edge. In step S1406, the average value calculated in step S1405 is compared with the distance of the edge. In step S1407, a missing portion is determined based on a comparison result of step S1406. After the process of step S1407, the interpolation process of step S1104 is performed.

As an alternative to the method of the processing flow of FIGS. 14A to 14C, an edge shape of the 3D data may be calculated. When the edge shape at each distance deviates from a predetermined pattern stored in advance by a predetermined ratio or more, a portion of the deviation may be determined as a missing portion. That is, a portion in which a cross-sectional shape of the 3D data at each distance deviates from a predetermined pattern by a predetermined amount or more may be determined as a missing portion.

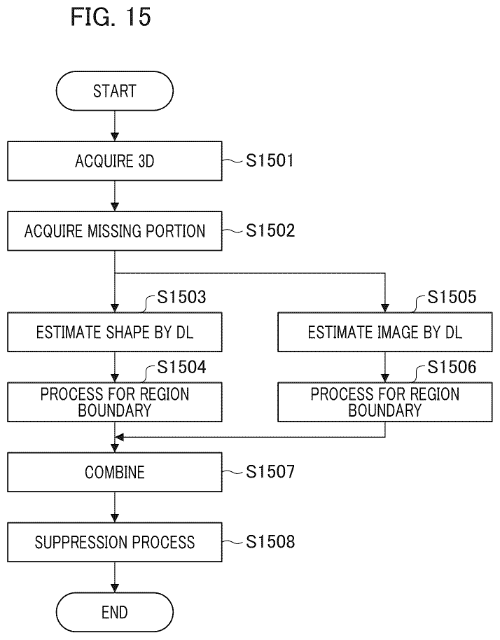

Next, FIG. 15 is a flowchart illustrating an example of the image interpolation process of step S1104. Step S1104 functions as an image adjustment unit that adjusts image information of an error region. That is, in the second embodiment, the image adjustment unit interpolates the error region (missing region).

FIG. 15 illustrates an example in which a shape of a missing portion and an image are interpolated by machine learning or deep learning. In step S1501, 3D data is acquired. In step S1502, information such as a position, a distance, or the like of the missing portion is acquired.

In step S1503, a restored shape in the case of restoration of the missing portion acquired in step S1502 is estimated based on the model trained by machine learning or DL (Deep Learning). Further, in step S1504, a filtering process is performed so that a stepped difference of a shape of a region boundary between the restored missing portion and another portion.

The filtering process of step S1504 includes, for example, a process of calculating a moving average of an edge of the boundary or a process of calculating a weighted average of an overlapping region. In this way, in steps S1503 and S1504, a shape of an error region (missing region) of the 3D data is interpolated by machine learning or DL (Deep Learning).

On the other hand, in step S1505, a restored image is estimated based on information regarding the missing portion acquired in step S1502 and a model trained by machine learning or DL (Deep Learning). Further, in step S1506, a filtering process is performed so that a stepped difference of an image of a region boundary between the restored missing portion and another portion. In this way, in steps S1505 and S1506, a shape of an error region (missing region) of the 3D data is interpolated by machine learning or DL (Deep Learning).

The filtering process of step S1506 also includes a process of calculating a moving average of luminance, saturation, or the like of the boundary or a process of calculating a weighted average of luminance, saturation, or the like of the overlapping region.

Further, in step S1507, the restored shape obtained in step S1504 and the restored image obtained in step S1506 are combined. In step S1508, a suppression process for the interpolated portion is performed.

The suppression process of step S1508 may be a process similar to the suppression process of step S105 in FIG. 10. That is, a suppression process such as a reduction in luminance, saturation, or contrast of the interpolated portion is performed.

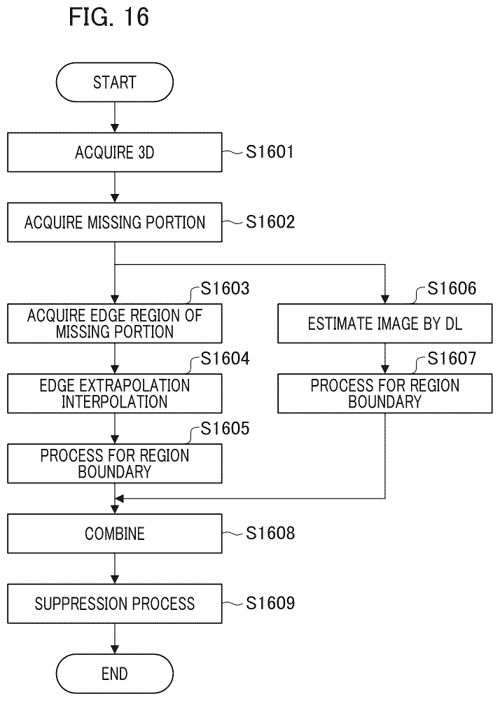

Next, FIG. 16 is a flowchart illustrating another example of the image interpolation process of step S1104. FIG. 16 illustrates an example in which a shape of a missing portion is subjected to extrapolation interpolation and an image of the missing portion is interpolated by machine learning or DL (Deep Learning).

In step S1601, 3D data is acquired. In step S1602, information such as a position, a distance, or the like of the missing portion is acquired. In step S1603, an edge region of the missing portion is acquired. In step S1604, an extrapolation interpolation process for an edge is performed.

Further, in step S1605, a filtering process is performed so that a stepped difference of a shape of a region boundary between the restored missing portion and another portion. That is, a process of reducing the stepped difference between the interpolated region and another region is performed.

Step S1605 may be a similar process to step S1504. In this way, in steps S1604 and 1605, a shape of an error region of the 3D data is interpolated through extrapolation interpolation.

Steps S1606 to S1609 are similar processes to steps S1505 to S1508 of FIG. 15, and thus description thereof will be omitted. As in the processing flow illustrated in FIG. 16, the shape of the missing portion may also be interpolated through extrapolation interpolation.

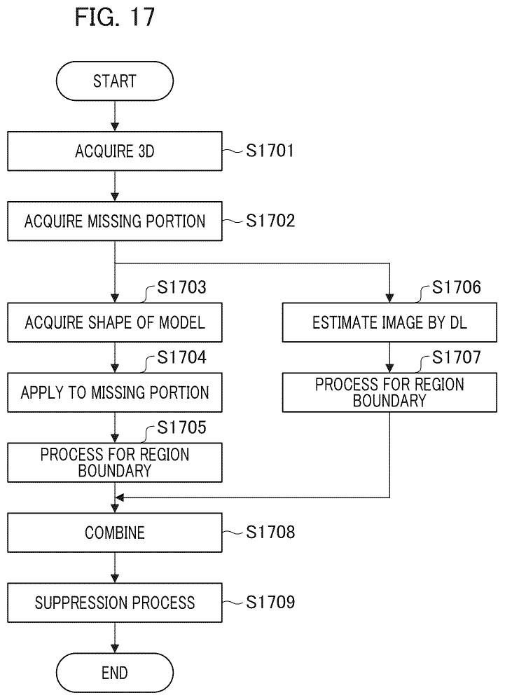

FIG. 17 is a flowchart illustrating still another example of the image interpolation process of step S1104. FIG. 17 illustrates an example in which a shape of a missing portion is interpolated using a model shape and an interpolation process is performed on an image by machine learning or DL (Deep Learning). Steps S1701 and S1702 are similar processes to steps S1502 and S1503 of FIG. 15, and thus description thereof will be omitted.

In step S1703, data of the mode shape stored in advance is acquired. Further, in step S1704, the missing portion is interpolated by applying the 3D data to the model shape. That is, a shape of an error region (missing portion) of the 3D data is interpolated using the data of the model shape stored in advance.

Steps S1705 and S1709 are similar processes to steps S1504 and S1508 of FIG. 15, and thus description thereof will be omitted. As illustrated in FIG. 17, the missing portion may be interpolated using the data of the model shape stored in advance.

In the first embodiment, it is possible to obtain a 3D image with a feeling of discomfort reduced by detecting an error region of 3D data and performing the image adjustment process. In the second embodiment, it is possible to obtain a 3D image with a feeling of discomfort reduced by detecting a missing portion of 3D data and interposing the missing portion. However, the processes in the first and second embodiments may be combined appropriately. Accordingly, even when a part of 3D data is distorted or a missing portion occurs, a 3D image with no feeling of discomfort can be obtained.

Error information regarding an error amount (extent of error), an error region, or the like may be stored as metadata of an image file of 3D data. An interpolation process or image adjustment such as a suppression process on an error region may be performed based on the error information stored as the metadata of the image file.

According to the foregoing embodiments, it is possible to provide an image processing apparatus or the like capable of generating an image with a small feeling of discomfort when a three-dimensional image generated through image processing is rotated.

While the present disclosure has been described with reference to embodiments, it is to be understood that the disclosure is not limited to the disclosed embodiments but is defined by the scope of the following claims.

In addition, as a part or the whole of the control according to the embodiments, a computer program realizing the function of the embodiments described above may be supplied to the image processing apparatus or the like through a network or various storage media. Then, a computer (or a CPU, an MPU, or the like) of the image processing apparatus or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-106475, filed on Jul. 1, 2024.

What is claimed is:

1. An image processing apparatus comprising at least one processor or circuit configured to function as:
an information acquisition unit configured to acquire an image and distance information of a subject;
a 3D data generation processing unit configured to generate 3D data of the subject based on the image and the distance information;
an error region detection unit configured to detect an error region of the 3D data; and
an image adjustment unit configured to adjust image information of the error region.

2. The image processing apparatus according to claim 1, wherein the image adjustment unit is configured to interpolate the error region.

3. The image processing apparatus according to claim 1, wherein the error region detection unit is configured to detect an error of the image or a shape of the 3D data.

4. The image processing apparatus according to claim 1, wherein the error region detection unit is configured to detect the error region of the 3D data by determining a semantic region of the 3D data by machine learning or Deep Learning.

5. The image processing apparatus according to claim 1, wherein the error region detection unit is configured to detect a region of which distance is equal to a predetermined distance or more as the error region of the 3D data based on the distance information.

6. The image processing apparatus according to claim 1, wherein the image adjustment unit is configured to perform at least one of an image suppression process and an upsampling process on the error region.

7. The image processing apparatus according to claim 6, wherein the suppression process includes a process of reducing at least one of luminance, saturation, contrast, and transparency of the image of the error region.

8. The image processing apparatus according to claim 7, wherein the suppression process is performed more strongly in accordance with an extent of an error of the error region.

9. The image processing apparatus according to claim 7, wherein the suppression process is performed more strongly toward a peripheral portion of the subject.

10. The image processing apparatus according to claim 1, wherein the error region includes a missing region in the 3D data.

11. The image processing apparatus according to claim 10, wherein the error region detection unit is configured to detect the missing region of the 3D data based on an arrangement relation of a semantic region of the 3D data.

12. The image processing apparatus according to claim 10, wherein the error region detection unit is configured to detect the missing region based on a distance distribution of an edge of the 3D data.

13. The image processing apparatus according to claim 10, wherein the error region detection unit is configured to detect the missing region based on a comparison result of the 3D data and a model shape stored in advance.

14. The image processing apparatus according to claim 1, wherein the image adjustment unit is configured to interpolate the image of the error region of the 3D data by machine learning or deep learning.

15. The image processing apparatus according to claim 1, wherein the image adjustment unit is configured to interpolate a shape of the error region of the 3D data by machine learning or deep learning.

16. The image processing apparatus according to claim 1, wherein the image adjustment unit is configured to interpolate a shape of the error region of the 3D data through extrapolation interpolation.

17. The image processing apparatus according to claim 1, wherein the image adjustment unit is configured to interpolate a shape of the error region of the 3D data using model shape data stored in advance.

18. The image processing apparatus according to claim 1, wherein the image adjustment unit is configured to perform a process of reducing a stepped difference of a boundary between a region on which the error region of the 3D data is interpolated and another region.

19. The image processing apparatus according to claim 1, wherein error information regarding the error region is stored as metadata of an image file, and the image adjustment unit is configured to adjust image information of the error region based on the error information stored as the metadata.

20. An image processing method comprising:
acquiring an image and distance information of a subject;
generating 3D data of the subject based on the image and the distance information;
detecting an error region of the 3D data; and
adjusting image information of the error region.

21. A non-transitory computer-readable storage medium configured to store a computer program comprising instructions for executing following processes of:
acquiring an image and distance information of a subject;
generating 3D data of the subject based on the image and the distance information;
detecting an error region of the 3D data; and
adjusting image information of the error region.
